(19) United States
(12) Patent Application Publication
(10) Pub. No.: US 2017/0084991 A1
(43) Pub. Date: Mar. 23, 2017

(54) WIRELESS POWER TRANSFER ANTENNA HAVING A SPLIT SHIELD

(71) Applicant: QUALCOMM Incorporated, San Diego, CA (US)

(72) Inventor: Gabriel Isaac Mayo, North Potomac, MD (US)

(21) Appl. No.: 14/856,631

(22) Filed: Sep. 17, 2015

(51) Int. Cl. H01Q 1/52; H02J 7/02; H02J 50/10; H02J 50/70; H01Q 1/48; H01Q 7/00

(52) U.S. Cl. CPC H01Q 1/526; H01Q 1/48; H01Q 7/00; H02J 50/10; H02J 50/70; H02J 7/025

(57) ABSTRACT

An antenna structure for wireless power transfer includes a ground plane configured to prevent passage of an electric field, at least one coil configured as an antenna and located over the ground plane, the ground plane contiguous over the coil, an insulator located between the ground plane and the at least one coil, and a shield adjacent the coil, the shield comprising a non-contiguous structure, the shield configured to allow the passage of a magnetic field to the at least one coil.

### FIELD

The present disclosure relates generally to wireless power. More specifically, the disclosure is directed to a wireless power transfer antenna having a split shield.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections that require cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices may overcome some of the deficiencies of wired charging solutions. As such, wireless charging systems and methods that efficiently and safely transfer power for charging rechargeable electronic devices are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides an antenna structure for wireless power transfer including a ground plane configured to prevent passage of an electric field, at least one coil configured as an antenna and located over the ground plane, the ground plane contiguous over the coil, an insulator located between the ground plane and the at least one coil, and a shield adjacent the coil, the shield comprising a non-contiguous structure, the shield configured to allow the passage of a magnetic field to the at least one coil.

Another aspect of the disclosure provides an antenna structure for a wireless power receiver including a ground plane configured to prevent passage of an electric field, at least one coil configured as an antenna and located over the ground plane, the ground plane contiguous over the coil, an insulator located between the ground plane and the at least one coil, a ferrite element located between the ground plane and the insulator, and a shield adjacent the coil, the shield comprising a non-contiguous structure, the shield configured to allow the passage of a magnetic field to the at least one coil, the ferrite element configured to configured to prevent passage of the magnetic field to the ground plane.

Another aspect of the disclosure provides a device for wireless power transfer including means for allowing passage of a magnetic field to an antenna for wireless charging, the means for allowing passage of the magnetic field preventing passage of an electric field generated by the antenna; and means for directing the magnetic field laterally away from the antenna.

Another aspect of the disclosure provides a method for wireless power transfer including allowing passage of a magnetic field to an antenna, preventing passage of an electric field, providing a balanced electro-motive force to the antenna, directing the magnetic field parallel to the antenna, and developing a current in the antenna responsive to the magnetic field, the current being received by a charge-receiving device configured to wirelessly receive power.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a functional block diagram of an exemplary wireless power transfer system, in accordance with exemplary embodiments of the invention.

FIG. 2 is a functional block diagram of exemplary components that may be used in the wireless power transfer system of FIG. 1, in accordance with various exemplary embodiments of the invention.

FIG. 3 is a schematic diagram of a portion of transmit circuitry or receive circuitry of FIG. 2 including a transmit or receive antenna, in accordance with exemplary embodiments of the invention.

FIG. 4 is a functional block diagram of a transmitter that may be used in the wireless power transfer system of FIG. 1, in accordance with exemplary embodiments of the invention.

FIG. 5 is a functional block diagram of a receiver that may be used in the wireless power transfer system of FIG. 1, in accordance with exemplary embodiments of the invention.

FIG. 6 is a schematic diagram of a portion of transmit circuitry that may be used in the transmit circuitry of FIG. 4.

FIG. 7 is a simplified diagram illustrating an exemplary embodiment of an antenna structure that can be used in a wireless power transfer system.

FIG. 8 is a cross-sectional diagram illustrating an exemplary embodiment of an antenna structure that can be used in a wireless power transfer system.

FIG. 9 is a cross-sectional diagram illustrating an exemplary embodiment of an antenna structure including an exemplary embodiment of a magnetic field superimposed thereon.

FIG. 10 is a cross-sectional diagram illustrating an exemplary embodiment of an antenna structure including an exemplary embodiment of a magnetic field and an electric field superimposed thereon.

FIG. 11 is a cross-sectional diagram illustrating an exemplary embodiment of a power transfer system having a transmit antenna structure and a receive antenna structure including an exemplary embodiment of a magnetic field superimposed thereon.

FIG. 12 is a schematic diagram illustrating an alternative exemplary embodiment of a spilt shield.

FIG. 13 is a flowchart illustrating an exemplary embodiment of a method for wireless power transfer.

FIG. 14 is a functional block diagram of an apparatus for wireless power transfer.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary embodiments of the invention and is not intended to represent the only embodiments in which the invention may be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. In some instances, some devices are shown in block diagram form.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving antenna” to achieve power transfer.

Devices that use wireless power transfer are becoming smaller and smaller. As these devices become smaller, it is desirable to reduce the size of the electronic circuits inside of the device. For example, one way of reducing the size of a device that can use wireless power transfer is to convert the electronics from an electrically balanced (also referred to as “differential”) configuration or structure to an electrically unbalanced (also referred to as a single-ended) configuration or structure. For example, converting a wireless power transmitter or wireless power receiver from one having a balanced circuit to one having a single-ended circuit reduces the overall size of the circuit, but may give rise to increased levels of electro-magnetic interference (EMI) emanating from the wireless power resonator. The increased EMI results from converting the antenna from an electrically balanced configuration (one in which two driving signals having opposite polarity are connected to opposite ends of the antenna and the electric and geometric center of the antenna may or may not be grounded) to a single-ended configuration (one in which one end of the antenna is grounded and a single drive signal is applied to the opposite end, resulting in a higher common mode signal at the antenna).

Wireless power transfer EMI compliance poses a significant challenge in terms of managing common mode signals at a wireless power transfer antenna. The antenna is electrically exposed to free space and the common mode component of the input signal projects displacement currents in the antenna that can result in high levels of EMI.

A prior approach to reducing common mode signals, and improving common mode rejection, is to interface to the wireless power transmit antenna with balanced electronics and to construct the antenna in symmetrical fashion, achieving electrical and geometric balance, which results in high common mode rejection. However, it is desirable to provide the electronics with a single-ended configuration to reduce the size and cost of the electronic circuits inside of the device.

Unfortunately, single-ended circuitry generally gives rise to elevated levels of EMI as a result of a common-mode voltage signal generated by the single-ended circuitry. The common-mode voltage signal gives rise to elevated levels of common-mode noise at the wireless power antenna.

The disclosure describes a split shield for a wireless power transfer antenna that reduces the level of a common-mode signal in the wireless power transfer antenna. Wireless charging systems can transfer charge to a charge receiving device by magnetic field coupling or by electric field coupling. A magnetic field coupling is also referred to as inductive coupling and generally uses what is referred to as an H-field, or B-field, coupling. An electrical field coupling is also referred to as capacitive coupling and generally uses what is referred to as an E-field coupling. The split shield can be incorporated into an antenna structure that controls both the magnetic field and the electric field. In an exemplary embodiment, the split shield can be incorporated into a resonant structure in which the antenna may be combined with capacitive and/or inductive components to create a resonator that control both the magnetic field and the electric field.

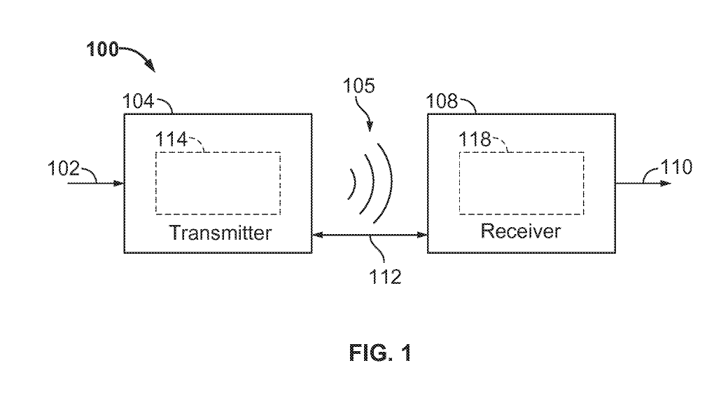

FIG. 1 is a functional block diagram of an exemplary wireless power transfer system 100, in accordance with exemplary embodiments of the invention. Input power 102 may be provided to a transmitter 104 from a power source (not shown) for generating a field 105 (e.g., magnetic or species of electromagnetic) for providing energy transfer. A receiver 108 may couple to the field 105 and generate output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship. When the resonant frequency of receiver 108 and the resonant frequency of transmitter 104 are substantially the same or very close, transmission losses between the transmitter 104 and the receiver 108 are reduced. As such, wireless power transfer may be provided over larger distances in contrast to purely inductive solutions that may require large coils to be very close (e.g., millimeters). Resonant inductive coupling techniques may thus allow for improved efficiency and power transfer over various distances and with a variety of inductive coil configurations.

The receiver 108 may receive power when the receiver 108 is located in an energy field 105 produced by the transmitter 104. The field 105 corresponds to a region where energy output by the transmitter 104 may be captured by a receiver 108. In some cases, the field 105 may correspond to the “near-field” of the transmitter 104 as will be further described below. The transmitter 104 may include a transmit antenna 114 (that may also be referred to herein as a coil) for outputting an energy transmission. The receiver 108 further includes a receive antenna 118 (that may also be referred to herein as a coil) for receiving or capturing energy from the energy transmission. The near-field may correspond to a region in which there are strong reactive fields resulting from the currents and charges in the transmit antenna 114 that minimally radiate power away from the transmit antenna 114. In some cases the near-field may correspond to a region that is within about one wavelength (or a fraction thereof) of the transmit antenna 114.

In accordance with the above therefore, in accordance with more particular embodiments, the transmitter 104 may be configured to output a time varying magnetic field 105 with a frequency corresponding to the resonant frequency of the transmit antenna 114. When the receiver is within the field 105, the time varying magnetic field 105 may induce a voltage in the receive antenna 118 that causes an electrical current to flow through the receive antenna 118. As described above, if the receive antenna 118 is configured to be resonant at the frequency of the transmit antenna 114, energy may be efficiently transferred. The AC signal induced in the receive antenna 118 may be rectified as described above to produce a DC signal that may be provided to charge or to power a load.

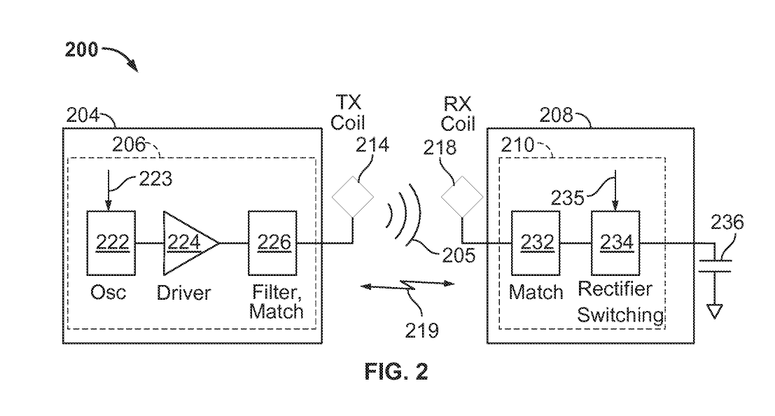

FIG. 2 is a functional block diagram of a wireless power transfer system 200 that includes exemplary components that may be used in the wireless power transfer system 100 of FIG. 1, in accordance with various exemplary embodiments of the invention. The transmitter 204 may include transmit circuitry 206 that may include an oscillator 222, a driver circuit 224, and a filter and matching circuit 226. The oscillator 222 may be configured to generate a signal at a desired frequency, such as 468.75 KHz, 6.78 MHz or 13.56 MHz, that may be adjusted in response to a frequency control signal 223. The oscillator signal may be provided to a driver circuit 224 configured to drive the transmit antenna 214 at, for example, a resonant frequency of the transmit antenna 214. The driver circuit 224 may be a switching amplifier configured to receive a square wave from the oscillator 222 and output a sine wave. For example, the driver circuit 224 may be a class E amplifier. A filter and matching circuit 226 may be also included to filter out harmonics or other unwanted frequencies and match the impedance of the transmitter 204 to the impedance of the transmit antenna 214. As a result of driving the transmit antenna 214, the transmitter 204 may wirelessly output power at a level sufficient for charging or powering an electronic device. As one example, the power provided may be for example on the order of 300 milliWatts to 5 Watts or 5 Watts to 40 Watts to power or charge different devices with different power requirements. Higher or lower power levels may also be provided.

The receiver 208 may include receive circuitry 210 that may include a matching circuit 232 and a rectifier and switching circuit 234 to generate a DC power output from an AC power input to charge a battery 236 as shown in FIG. 2 or to power a device (not shown) coupled to the receiver 208. The matching circuit 232 may be included to match the impedance of the receive circuitry 210 to the impedance of the receive antenna 218. The receiver 208 and transmitter 204 may additionally communicate on a separate communication channel 219 (e.g., Bluetooth, zigbee, cellular, etc.). The receiver 208 and transmitter 204 may alternatively communicate via in-band signaling using characteristics of the wireless field 205.

The receiver 208 may initially have a selectively disablable associated load (e.g., battery 236), and may be configured to determine whether an amount of power transmitted by transmitter 204 and received by receiver 208 is appropriate for charging a battery 236. Further, receiver 208 may be configured to enable a load (e.g., battery 236) upon determining that the amount of power is appropriate.

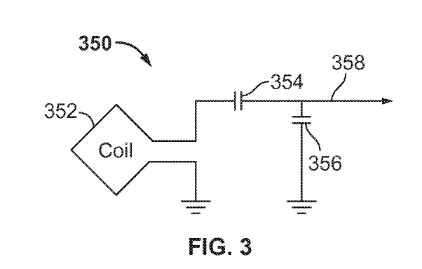

FIG. 3 is a schematic diagram of a portion of transmit circuitry 206 or receive circuitry 210 of FIG. 2 including a transmit or receive antenna 352, in accordance with exemplary embodiments of the invention. As illustrated in FIG. 3, transmit or receive circuitry 350 used in exemplary embodiments including those described below may include an antenna 352. The antenna 352 may also be referred to or be configured as a “loop” antenna 352. The antenna 352 may also be referred to herein or be configured as a “magnetic” antenna or an induction coil. The term “antenna” generally refers to a component that may wirelessly output or receive energy for coupling to another “antenna.” The antenna 352 may also be referred to as a coil of a type that is configured to wirelessly output or receive power. As used herein, an antenna 352 is an example of a “power transfer component” of a type that is configured to wirelessly output and/or receive power. The antenna 352 may be configured to include an air core or a physical core such as a ferrite core (not shown).

The antenna 352 may form a portion of a resonant circuit configured to resonate at a resonant frequency. The resonant frequency of the loop or magnetic antenna 352 is based on the inductance and capacitance. Inductance may be simply the inductance created by the antenna 352, whereas, capacitance may be added to create a resonant structure (e.g., a capacitor may be electrically connected to the antenna 352 in series or in parallel) at a desired resonant frequency. As a non-limiting example, capacitor 354 and capacitor 356 may be added to the transmit or receive circuitry 350 to create a resonant circuit that resonates at a desired frequency of operation. For larger diameter antennas, the size of capacitance needed to sustain resonance may decrease as the diameter or inductance of the loop increases. As the diameter of the antenna increases, the efficient energy transfer area of the near-field may increase. Other resonant circuits formed using other components are also possible. As another non-limiting example, a capacitor (not shown) may be placed in parallel between the two terminals of the antenna 352. For transmit antennas, a signal 358 with a frequency that substantially corresponds to the resonant frequency of the antenna 352 may be an input to the antenna 352. For receive antennas, the signal 358 may be the output that may be rectified and used to power or charge a load.

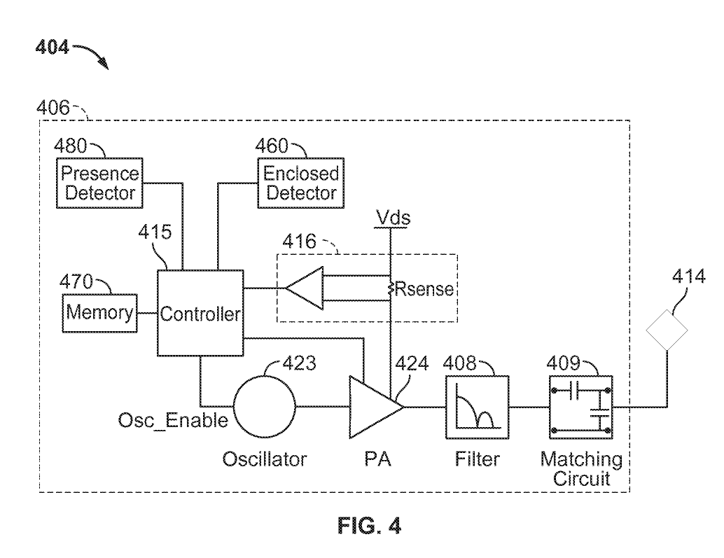

FIG. 4 is a functional block diagram of a transmitter 404 that may be used in the wireless power transfer system of FIG. 1, in accordance with exemplary embodiments of the invention. The transmitter 404 may include transmit circuitry 406 and a transmit antenna 414. The transmit antenna 414 may be the antenna 352 as shown in FIG. 3. The transmit antenna 414 may be configured as the transmit antenna 214 as described above in reference to FIG. 2. In some implementations, the transmit antenna 414 may be a coil (e.g., an induction coil). In some implementations, the transmit antenna 414 may be associated with a larger structure, such as a pad, table, mat, lamp, or other stationary configuration. Transmit circuitry 406 may provide power to the transmit antenna 414 by providing an oscillating signal resulting in generation of energy (e.g., magnetic flux) about the transmit antenna 414. Transmitter 404 may operate at any suitable frequency. By way of example, transmitter 404 may operate at the 6.78 MHz ISM band.

Transmit circuitry 406 may include a fixed impedance matching circuit 409 for matching the impedance of the transmit circuitry 406 (e.g., 50 ohms) to the impedance of the transmit antenna 414 and a low pass filter (LPF) 408 configured to reduce harmonic emissions to levels to prevent self-jamming of devices coupled to receivers 108 (FIG. 1). Other exemplary embodiments may include different filter topologies, including but not limited to, notch filters that attenuate specific frequencies while passing others and may include an adaptive impedance match, that may be varied based on measurable transmit metrics, such as output power to the antenna 414 or DC current drawn by the driver circuit 424. Transmit circuitry 406 further includes a driver circuit 424 configured to drive a signal as determined by an oscillator 423. The transmit circuitry 406 may be comprised of discrete devices or circuits, or alternately, may be comprised of an integrated assembly.

Transmit circuitry 406 may further include a controller 415 for selectively enabling the oscillator 423 during transmit phases (or duty cycles) for specific receivers, for adjusting the frequency or phase of the oscillator 423, and for adjusting the output power level for implementing a communication protocol for interacting with neighboring devices through their attached receivers. It is noted that the controller 415 may also be referred to herein as a processor. The controller may be coupled to a memory 470. Adjustment of oscillator phase and related circuitry in the transmission path may allow for reduction of out of band emissions, especially when transitioning from one frequency to another.

The transmit circuitry 406 may further include a load sensing circuit 416 for detecting the presence or absence of active receivers in the vicinity of the near-field generated by transmit antenna 414. By way of example, a load sensing circuit 416 monitors the current flowing to the driver circuit 424, that may be affected by the presence or absence of active receivers in the vicinity of the field generated by transmit antenna 414 as will be further described below. Detection of changes to the loading on the driver circuit 424 are monitored by controller 415 for use in determining whether to enable the oscillator 423 for transmitting energy and to communicate with an active receiver. The transmit antenna 414 may be implemented with a Litz wire or as an antenna strip with the thickness, width and metal type selected to keep resistive losses low.

The transmitter 404 may gather and track information about the whereabouts and status of receiver devices that may be associated with the transmitter 404. Thus, the transmit circuitry 406 may include a presence detector 480, an enclosed detector 460, or a combination thereof, connected to the controller 415 (also referred to as a processor herein). The controller 415 may adjust an amount of power delivered by the driver circuit 424 in response to presence signals from the presence detector 480 and the enclosed detector 460. The transmitter 404 may receive power through a number of power sources, such as, for example, an AC-DC converter (not shown) to convert AC power present in a building, a DC-DC converter (not shown) to convert a DC power source to a voltage suitable for the transmitter 404, or directly from a DC power source (not shown).

As a non-limiting example, the presence detector 480 may be a motion detector utilized to sense the initial presence of a device to be charged that is inserted into the coverage area of the transmitter 404. After detection, the transmitter 404 may be turned on and the power received by the device may be used to toggle a switch on the receiver device in a pre-determined manner, which in turn results in changes to the driving point impedance of the transmitter 404.

As another non-limiting example, the presence detector 480 may be a detector capable of detecting a human, for example, by infrared detection, motion detection, or other suitable means. In some exemplary embodiments, there may be regulations limiting the amount of power that a transmit antenna 414 may transmit at a specific frequency. In some cases, these regulations are meant to protect humans from electromagnetic radiation. However, there may be environments where a transmit antenna 414 is placed in areas not occupied by humans, or occupied infrequently by humans, such as, for example, garages, factory floors, shops, and the like. If these environments are free from humans, it may be permissible to increase the power output of the transmit antenna 414 above the normal power restrictions regulations. In other words, the controller 415 may adjust the power output of the transmit antenna 414 to a regulatory level or lower in response to human presence and adjust the power output of the transmit antenna 414 to a level above the regulatory level when a human is outside a regulatory distance from the wireless charging field of the transmit antenna 414.

As a non-limiting example, the enclosed detector 460 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary embodiments, a method by which the transmitter 404 does not remain on indefinitely may be used. In this case, the transmitter 404 may be programmed to shut off after a user-determined amount of time. This feature prevents the transmitter 404, notably the driver circuit 424, from running long after the wireless devices in its perimeter are fully charged. This event may be due to the failure of the circuit to detect the signal sent from either the repeater or the receive antenna 218 that a device is fully charged. To prevent the transmitter 404 from automatically shutting down if another device is placed in its perimeter, the transmitter 404 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

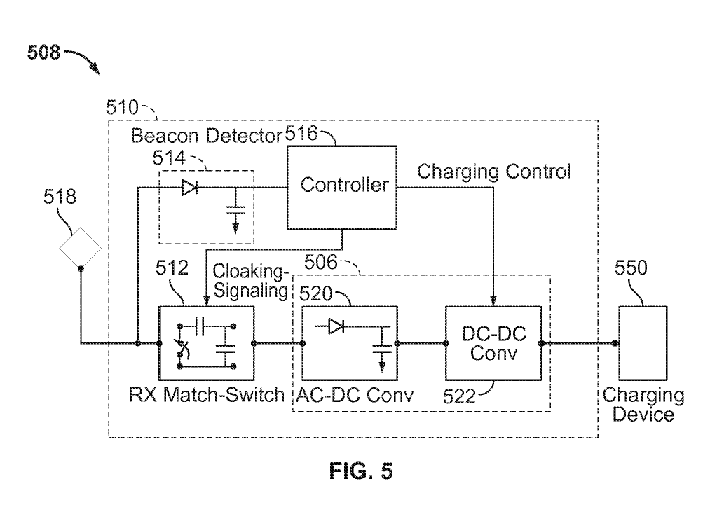

FIG. 5 is a functional block diagram of a receiver 508 that may be used in the wireless power transfer system of FIG. 1, in accordance with exemplary embodiments of the invention. The receiver 508 includes receive circuitry 510 that may include a receive antenna 518. Receiver 508 further couples to device 550 for providing received power thereto. It should be noted that receiver 508 is illustrated as being external to device 550 but may be integrated into device 550. Energy may be propagated wirelessly to receive antenna 518 and then coupled through the rest of the receive circuitry 510 to device 550. By way of example, the charging device may include devices such as mobile phones, portable music players, laptop computers, tablet computers, computer peripheral devices, communication devices (e.g., Bluetooth devices), digital cameras, hearing aids (and other medical devices), wearable devices, and the like.

Receive antenna 518 may be tuned to resonate at the same frequency, or within a specified range of frequencies, as transmit antenna 414 (FIG. 4). Receive antenna 518 may be similarly dimensioned with transmit antenna 414 or may be differently sized based upon the dimensions of the associated device 550. By way of example, device 550 may be a portable electronic device having diametric or length dimension smaller than the diameter or length of transmit antenna 414. In such an example, receive antenna 518 may be implemented as a multi-turn coil in order to reduce the capacitance value of a tuning capacitor (not shown) and increase the receive coil's impedance. By way of example, receive antenna 518 may be placed around the substantial circumference of device 550 in order to maximize the antenna diameter and reduce the number of loop turns (i.e., windings) of the receive antenna 518 and the inter-winding capacitance.

Receive circuitry 510 may provide an impedance match to the receive antenna 518. Receive circuitry 510 includes power conversion circuitry 506 for converting received energy into charging power for use by the device 550. Power conversion circuitry 506 includes an AC-to-DC converter 520 and may also include a DC-to-DC converter 522. AC-to-DC converter 520 rectifies the RF energy signal received at receive antenna 518 into a non-alternating power with an output voltage. The DC-to-DC converter 522 (or other power regulator) converts the rectified energy signal into an energy potential (e.g., voltage) that is compatible with device 550 with an output voltage and output current. Various AC-to-DC converters are contemplated, including partial and full rectifiers, regulators, bridges, doublers, as well as linear and switching converters.

Receive circuitry 510 may further include RX matching and switching circuitry 512 for connecting receive antenna 518 to the power conversion circuitry 506 or alternatively for disconnecting the power conversion circuitry 506. Disconnecting receive antenna 518 from power conversion circuitry 506 not only suspends charging of device 550, but also changes the “load” as “seen” by the transmitter 404 (FIG. 2).

When multiple receivers 508 are present in a transmitter's near-field, it may be desirable to adjust the loading and unloading of one or more receivers to enable other receivers to more efficiently couple to the transmitter. A receiver 508 may also be cloaked in order to eliminate coupling to other nearby receivers or to reduce loading on nearby transmitters. This “unloading” of a receiver is also known herein as a “cloaking.” Furthermore, this switching between unloading and loading controlled by receiver 508 and detected by transmitter 404 may provide a communication mechanism from receiver 508 to transmitter 404. Additionally, a protocol may be associated with the switching that enables the sending of a message from receiver 508 to transmitter 404. By way of example, a switching speed may be on the order of 100 μsec.

In an exemplary embodiment, communication between the transmitter 404 and the receiver 508 may take place either via an “out-of-band” separate communication channel/antenna or via “in-band” communication that may occur via modulation of the field used for power transfer.

Receive circuitry 510 may further include signaling detector and beacon circuitry 514 used to identify received energy fluctuations that may correspond to informational signaling from the transmitter to the receiver. Furthermore, signaling and beacon circuitry 514 may also be used to detect the transmission of a reduced signal energy (i.e., a beacon signal) and to rectify the reduced signal energy into a nominal power for awakening either un-powered or power-depleted circuits within receive circuitry 510 in order to configure receive circuitry 510 for wireless charging.

Receive circuitry 510 further includes controller 516 for coordinating the processes of receiver 508 described herein including the control of RX matching and switching circuitry 512 described herein. It is noted that the controller 516 may also be referred to herein as a processor. Cloaking of receiver 508 may also occur upon the occurrence of other events including detection of an external wired charging source (e.g., wall/USB power) providing charging power to device 550. Controller 516, in addition to controlling the cloaking of the receiver, may also monitor beacon circuitry 514 to determine a beacon state and extract messages sent from the transmitter 404. Controller 516 may also adjust the DC-to-DC converter 522 for improved performance.

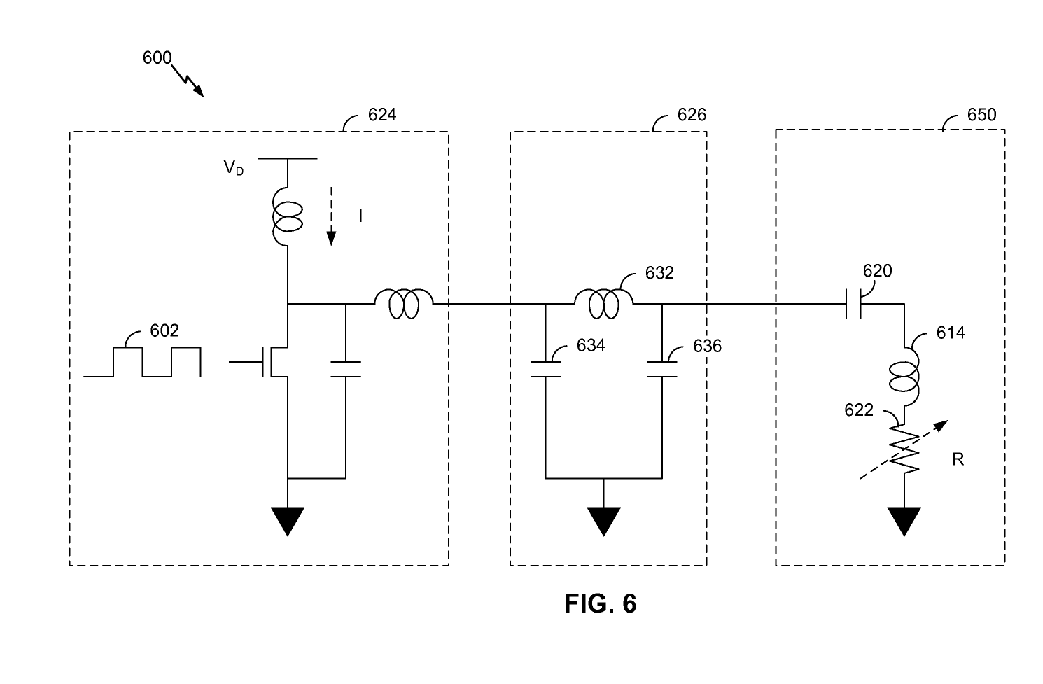

FIG. 6 is a schematic diagram of a portion of transmit circuitry 600 that may be used in the transmit circuitry 406 of FIG. 4. The transmit circuitry 600 may include a driver circuit 624 as described above in FIG. 4. As described above, the driver circuit 624 may be a switching amplifier that may be configured to receive a square wave and output a sine wave to be provided to the transmit circuit 650. In some cases the driver circuit 624 may be referred to as an amplifier circuit. The driver circuit 624 is shown as a class E amplifier; however, any suitable driver circuit 624 may be used in accordance with embodiments of the invention. The driver circuit 624 may be driven by an input signal 602 from an oscillator 423 as shown in FIG. 4. The driver circuit 624 may also be provided with a drive voltage V_{D} that is configured to control the maximum power that may be delivered through a transmit circuit 650. To eliminate or reduce harmonics, the transmit circuitry 600 may include a filter circuit 626. The filter circuit 626 may be a three pole (capacitor 634, inductor 632, and capacitor 636) low pass filter circuit 626.

The signal output by the filter circuit 626 may be provided to a transmit circuit 650 comprising an antenna 614. The transmit circuit 650 may include a series resonant circuit having a capacitance 620 and inductance (e.g., that may be due to the inductance or capacitance of the antenna or to an additional capacitor component) that may resonate at a frequency of the filtered signal provided by the driver circuit 624. The load of the transmit circuit 650 may be represented by the variable resistor 622. The load may be a function of a wireless power receiver 508 that is positioned to receive power from the transmit circuit 650.

In an exemplary embodiment, a split shield for a wireless power transfer resonator reduces the level of a common-mode signal in the wireless power transfer resonator, and may be suited in particular for single-ended resonator circuits. Wireless charging systems can transfer charge to a charge receiving device by magnetic field coupling or by electric field coupling. A magnetic field coupling is also referred to as inductive coupling and generally uses what is referred to as an H-field, or B-field, coupling. An electrical field coupling is also referred to as capacitive coupling and generally uses what is referred to as an E-field coupling. The split shield can be incorporated into a resonator structure that controls both the magnetic field and the electric field.

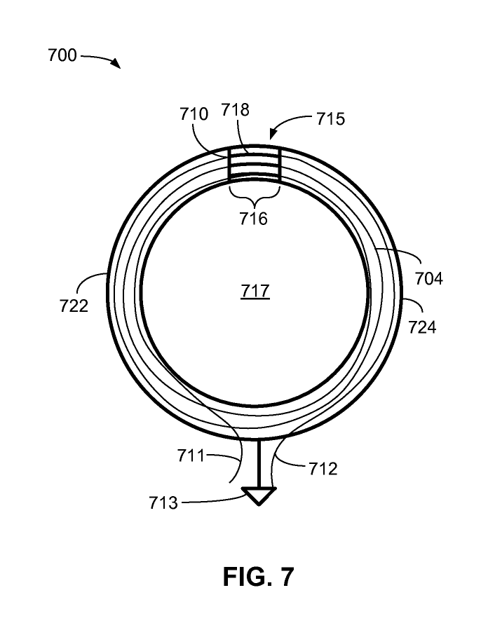

FIG. 7 is a simplified diagram illustrating an exemplary embodiment of an antenna structure 700 that can be used in a wireless power transfer system. The antenna structure 700 will be described in the context of a wireless power receiver. However, the antenna structure 700 can also be associated with a wireless power transmitter. While the following description of the exemplary embodiments describes embodiments relative to an antenna that can be configured as part of a circuit for power transfer, the shields and embodiments thereof described herein may also be incorporated into resonant structures configured for resonant power transfer systems as well. In an exemplary embodiment, the antenna structure 700 comprises a receive antenna 718 having three turns that may be wound in the shape of a coil 704 and coil terminals 711 and 712. However, the receive antenna 718 may have a coil 704 having more or fewer than three turns. Although not shown in FIG. 7, the receive antenna 718 may be coupled to one or more capacitors to create a resonant structure. A split shield 710 is located adjacent to one side of the receive antenna 718. In an exemplary embodiment, the split shield 710 is generally annular in shape and comprises an opening, in the region 717. The split shield 710 comprises substantially symmetrical legs 722 and 724, and a gap 716, or opening, in the region 715. The gap 716 in the split shield 710 exposes a portion of the coil 704 in the region 715. In an exemplary embodiment, the split shield 710 may be fabricated from an electrically conductive material. In an exemplary embodiment, the electrically conductive material from which the split shield 710 may be formed may comprise a planar metallization layer, which may be one of the layers from which the antenna structure 700 may be fabricated. In an exemplary embodiment in which the antenna structure 700 is implemented in a single-ended circuit, the coil terminal 711 can be coupled to the receive circuitry 510 (FIG. 5) and the coil terminal 712 can be coupled to a ground reference, such as a circuit ground 713. In such an embodiment, the coil 704 may be a referred to as a single-ended coil and such implementation may be referred to as an electrically unbalanced structure. In an exemplary embodiment, the split shield 710 is also coupled to the circuit ground 713 opposite the gap 716, such that the legs 722 and 724 are substantially equal in size. In an exemplary embodiment, the circuit ground 713 forms a center node from which the legs 722 and 724 extend.

In an exemplary embodiment, the receive antenna 718 is fabricated as a planar annular structure with the split shield 710 being located adjacent to one side of the receive antenna 718. The receive antenna 718 with the adjacent split shield 710 located on one side of the receive antenna 718 is effective in improving common mode rejection by minimizing the common mode voltage in the receive antenna 718. The reduction in the common mode voltage allows the use of single-ended circuitry, such as, for example, half-bridge rectification circuitry, thus reducing circuit footprint, and component cost, and lending well to miniaturization.

The center of the split shield 710 is referenced to circuit ground 713 so that the split shield 710 develops a substantially balanced electro-motive force (EMF), i.e., an induced voltage, symmetrically on both legs 722 and 724. Common mode emissions from the receive antenna 718 are reduced by masking the coil 704 of the receive antenna 718 with the split shield 710, where the split shield 710 externally presents only a single, balanced turn. The split shield 710 comprises a single termination at the circuit ground 713 while the legs 722 and 724 extending from the circuit ground 713 are unterminated forming a non-contiguous shield, thereby having no inductance. The split shield 710 reduces the exposed EMF and the balanced nature of the split shield 710 cancels a significant portion of the common mode signal in the receive resonator 718. Moreover, in an exemplary embodiment where the split shield may not develop a completely balanced EMF, but may develop an EMF lower than an EMF developed by the receive antenna 718, the split shield 710 still reduces electromagnetic interference emissions from the receive antenna 718.

The gap 716 in the split shield 710 prevents current from being developed in the split shield 710 and attenuates a substantial portion of the electric field in the receive antenna 718, thus attenuating EMI radiating from the coil. The split shield 710 provides a conductive return path to the circuit ground 713 for the electric field, rather than projecting the electric field into space through exposed displacement capacitance.

The balanced nature of the split shield 710 cancels the projected electric field from the split shield 710. The electric field from the split shield 710 is due to the induced voltage from the electro motive force (EMF), but the voltage developed on the split shield 710 is only +/−½ turn, and it cancels at a distance as it is well balanced. The split shield 710 cancels the E-field along the center axis (z-axis) of the split shield 710 and increasingly cancels the E-field off center as distance away from the z-axis increases. In an exemplary embodiment, most of the E-field cancellation is realized within three or four antenna diameters away from the center of the z-axis. In the exemplary embodiment shown in FIG. 7, the z-axis is into and out of the page, generally perpendicular to the major surface of the split shield 710. In an exemplary embodiment, it is also possible to have a split shield where the legs may not be perfectly symmetrical.

In an exemplary embodiment, the receive antenna 718 may be configured as a resonant structure configured to resonate at a frequency of an externally generated magnetic field. The electrical current generated in the coil 704 in response to the externally generated magnetic field may be output to power or charge a load.

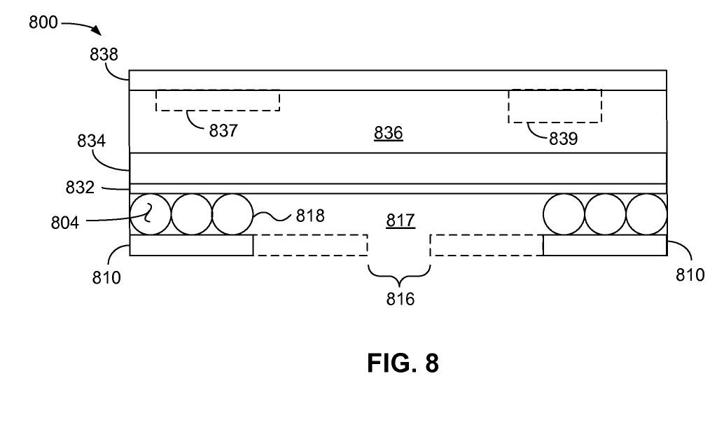

FIG. 8 is a cross-sectional diagram illustrating an exemplary embodiment of an antenna structure 800 that can be used in a wireless power transfer system. Elements in FIG. 8 that are similar to elements in FIG. 7 are labeled using the nomenclature 8XX, where an element labeled 8XX in FIG. 8 corresponds to an element labeled 7XX in FIG. 7. The antenna structure 800 will be described in the context of a wireless power receiver. However, the antenna structure 800 can also be associated with a wireless power transmitter. In an exemplary embodiment, the antenna structure 800 comprises a receive antenna 818 having three turns that may be wound in the shape of a coil 804 and a split shield 810 located adjacent to one side of the receive antenna 818. The receive antenna 818 and the split shield 810 are similar to the receive antenna 718 and the split shield 710 described above. In an exemplary embodiment, the split shield 810 is generally annular in shape and comprises an opening in the region 817.

The antenna structure 800 also comprises a spacer 832, a ferrite element 834 and a ground plane 838. In an exemplary embodiment, the spacer 832 may comprise an insulating material, such as, for example, a dielectric material.

In an exemplary embodiment, the spacer 832 is located adjacent to the side of the receive antenna 818 that is opposite the split shield 810. The ferrite element 834 may be located adjacent to the spacer 832.

In an exemplary embodiment, the ground plane 838 can be a ground plane associated with a printed circuit board (PCB), printed circuit assembly (PCA), or another structure on which circuits may be located. In an exemplary embodiment. The ground plane 838 may be spaced apart from the ferrite element 834 so as to create a void 836. Alternatively, the void 836 may contain some or all of the ferrite element 834 or insulator material of the spacer 832. Alternatively, the void may provide the electrically insulating properties of the spacer 832. Exemplary circuit elements 837 and 839 may be located in the void 836. For example, exemplary circuit elements 837 and 839 may comprise portions of the receive circuitry 510 (FIG. 5) and may be located in the void 836. In an exemplary embodiment in which the antenna structure 800 may be implemented in a receiver or in a transmitter, the void 836 may be eliminated. Moreover, in an exemplary embodiment in which the antenna structure 800 may be implemented in a receiver or in a transmitter, the ferrite 834 may be eliminated if the void 836 is sufficiently large.

In an exemplary embodiment, the ferrite element 834 provides a magnetically conductive path for the B-field which may otherwise be blocked by the ground plane 838. In an exemplary embodiment, the gap 816 in the split shield 810 prevents current from circulating in the split shield, allowing the passage of B-field through the split shield 810 so that magnetic coupling can be achieved between the receive antenna 818 and a transmit antenna (not shown). The ground plane 838 blocks the electric field (E-field) from radiating upward from the coil 804 (projecting up in FIG. 8). In an exemplary embodiment, the ground plane 838 also provides the circuit ground 713 (FIG. 7). The split shield 810 applied to the receive antenna 810 at the bottom of FIG. 8 prevents the E-field from radiating downward from the receive resonator 810 but does not affect the B-field due to the gap 816 in the split shield 810 preventing current from circulating around the annulus ring of the split shield 810.

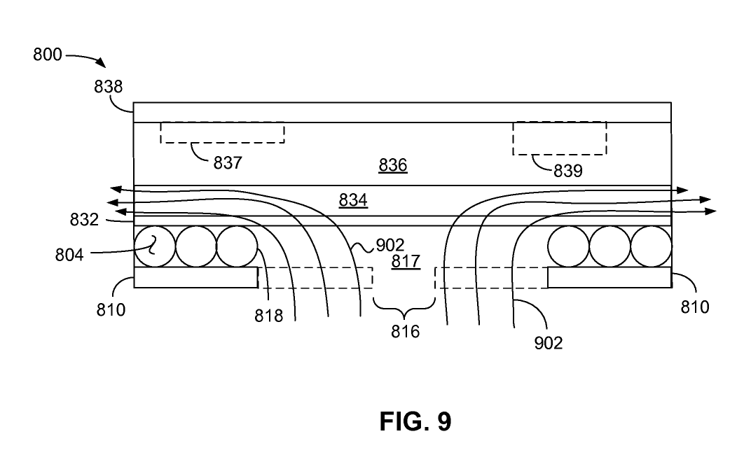

FIG. 9 is a cross-sectional diagram illustrating an exemplary embodiment of an antenna structure 800 including an exemplary embodiment of a magnetic field superimposed thereon. Details of the resonator structure 800 of FIG. 8 that are shown in FIG. 9 will not be repeated. In an exemplary embodiment, a magnetic field coupling is also referred to as inductive coupling and generally uses what is referred to as an H-field, or B-field, coupling. An exemplary B-field is shown in FIG. 9 having lines 902. The B-field lines 902 are shown as passing through the split shield 810 and traveling through the region 817 such that a magnetic field coupling is created between the transmit antenna (not shown) and the receive antenna 818. The ferrite element 834 conducts the B-field laterally to the periphery of the antenna structure 800. The periphery of the antenna structure 800 is devoid of any shielding and is unshielded. In an exemplary embodiment, the lack of shielding around the periphery of the antenna structure 800 facilitates the ferrite element 834 operating to conduct the B-field laterally to the periphery of the antenna structure 800 such that the B-field does not affect the operation of the circuit elements 837 and 839.

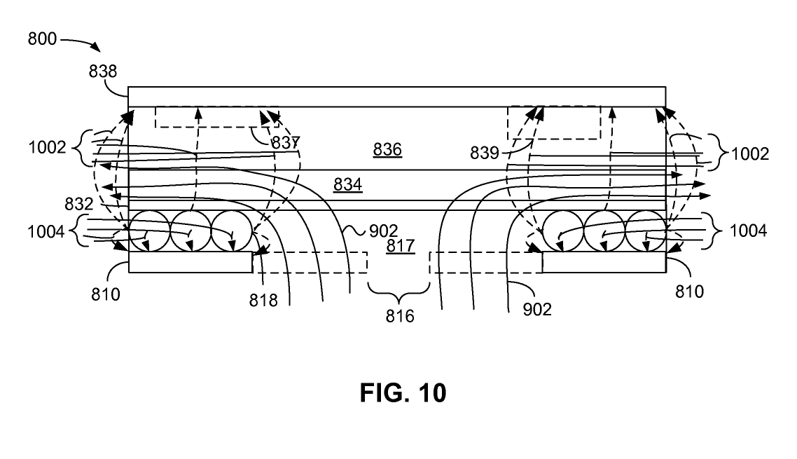

FIG. 10 is a cross-sectional diagram illustrating an exemplary embodiment of an antenna structure 800 including an exemplary embodiment of a magnetic field and an electric field superimposed thereon. Details of the resonator structure 800 of FIG. 8 and FIG. 9 that are shown in FIG. 10 will not be repeated. In an exemplary embodiment, an electrical field coupling is also referred to as capacitive or displacement capacitance coupling and generally uses what is referred to as an E-field coupling. An exemplary E-field is shown in FIG. 10 having lines 1002 and 1004. The E-field lines 1002 are shown as passing from the receive antenna 818 but being confined by the ground plane 838. The E-field lines 1004 are shown as passing from the receive antenna 818 but being confined by the split shield 810. In an exemplary embodiment, the E-field 1002 being confined by the ground plane 838 and the E-field 1004 being confined by the split shield 810 prevents any E-field energy from radiating away from the antenna structure 800.

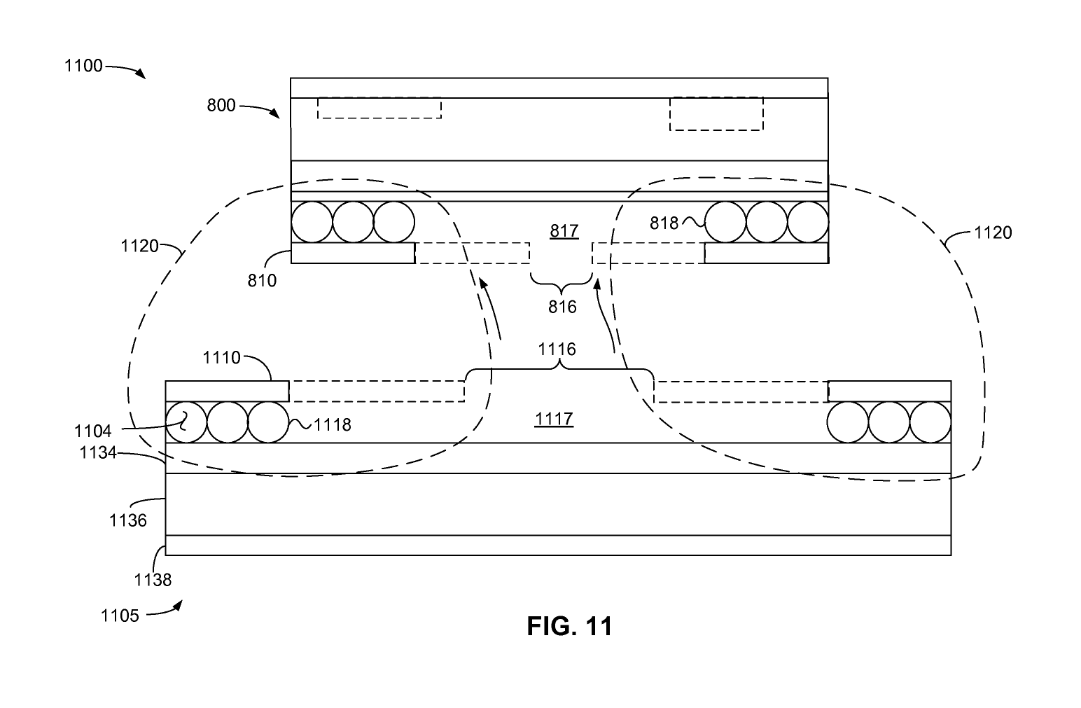

FIG. 11 is a cross-sectional diagram illustrating an exemplary embodiment of a power transfer system 1100 having a transmit antenna structure 1105 and a receive antenna structure 800 including an exemplary embodiment of a magnetic field superimposed thereon.

In the embodiment shown in FIG. 11, the antenna structure 800 is an example of a receive antenna structure as described above with reference to FIGS. 8-10, and will not be described again in detail. The power transfer system 1100 also includes an exemplary embodiment of an antenna structure 1105. In an exemplary embodiment, the antenna structure 1105 can be a transmit antenna structure configured to establish a magnetic field coupling with the antenna structure 800. In an exemplary embodiment, the antenna structure 1105 and the antenna structure 800 may be configured to operate as resonant structures.

In an exemplary embodiment, the antenna structure 1105 comprises a transmit antenna 1118 having a three turn coil 1104 and a split shield 1110 located adjacent to one side of the transmit antenna 1118. The transmit antenna 1118 and the split shield 1110 are similar to the receive antenna 718 and the split shield 710 described above. In an exemplary embodiment, the split shield 1110 is generally annular in shape and comprises an opening, in the region 1117, and comprises a gap 1116 configured to allow the passage of the B-field.

In an exemplary embodiment, the antenna structure 1105 may also comprise a ferrite element 1134 and a ground plane 1138 defining a void 1136 therebetween. In an exemplary embodiment, the ferrite element 1134 is optional. If the ferrite element 1134 is omitted, then the void 1136, or an optional insulating material, such as a dielectric material, insulates the split shield 1110 from the transmit antenna 1118. If the void 1136 is omitted, then the ferrite element 1134 insulates the split shield 1110 from the transmit antenna 1118. In an exemplary embodiment, the ferrite element 1134 is located adjacent to the side of the transmit antenna 1118 that is opposite the split shield 1110.

In an exemplary embodiment, when the antenna structure 1105 and the antenna structure 800 are in resonance and the transmit antenna 1118 is energized with a power transfer signal, a magnetic field coupling 1120 can be established between the transmit antenna 1118 and the receive antenna 818. Although shown in FIG. 11 as two elements, the magnetic field coupling 1120 is generally toroidal, or annular in shape, and is a single magnetic field. In an exemplary embodiment, the split shield 810 and the split shield 1110 allow the establishment of a magnetic field coupling between the antenna structure 1105 and the antenna structure 800, while minimizing E-field energy from emanating from the antenna structure 1105 and the antenna structure 800 and while conducting the B-field laterally to the periphery of the antenna structure 1105 and the antenna structure 800 such that the B-field does not affect the operation of the circuit elements (not shown) in the antenna structure 1105 and the antenna structure 800 as described above.

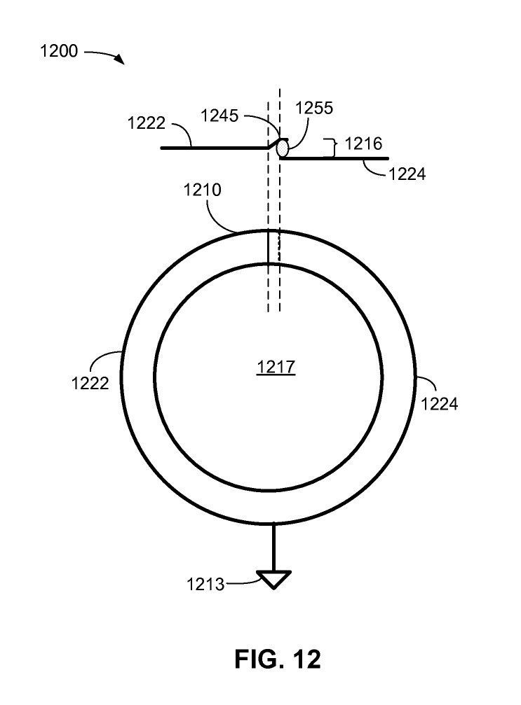

FIG. 12 is a schematic diagram illustrating an alternative exemplary embodiment of a spilt shield structure 1200f. In an exemplary embodiment, the split shield 1210 may be an alternative embodiment of the split shield 710 described in FIG. 7. In an exemplary embodiment, the split shield 1210 is generally annular in shape and comprises an opening, in the region 1217. The split shield 1210 comprises substantially symmetrical legs 1222 and 1224, and a gap 1216. The gap 1216 is formed by overlapping the legs 1222 and 1224 to create an overlap 1245. The gap 1216 in the overlap 1245 may be partially or completely filled with an electrical insulator 1255. In an exemplary embodiment, the electrical insulator 1255 may comprise a dielectric, or other material. In an exemplary embodiment, the split shield 1210 may be fabricated from an electrically conductive material. In an exemplary embodiment, the electrically conductive material from which the split shield 1210 may be formed may comprise a planar metallization layer, which may be one of the layers from which the antenna structure 700 (FIG. 7) may be fabricated. In an exemplary embodiment, the split shield 1210 is also coupled to the circuit ground 1213 opposite the gap 1216, such that the legs 1222 and 1224 are substantially equal in size. In an exemplary embodiment, the circuit ground 1213 forms a center node from which the legs 1222 and 1224 extend. The split shield 1210 may operate substantially as described with respect to the exemplary embodiments of the split shields described herein.

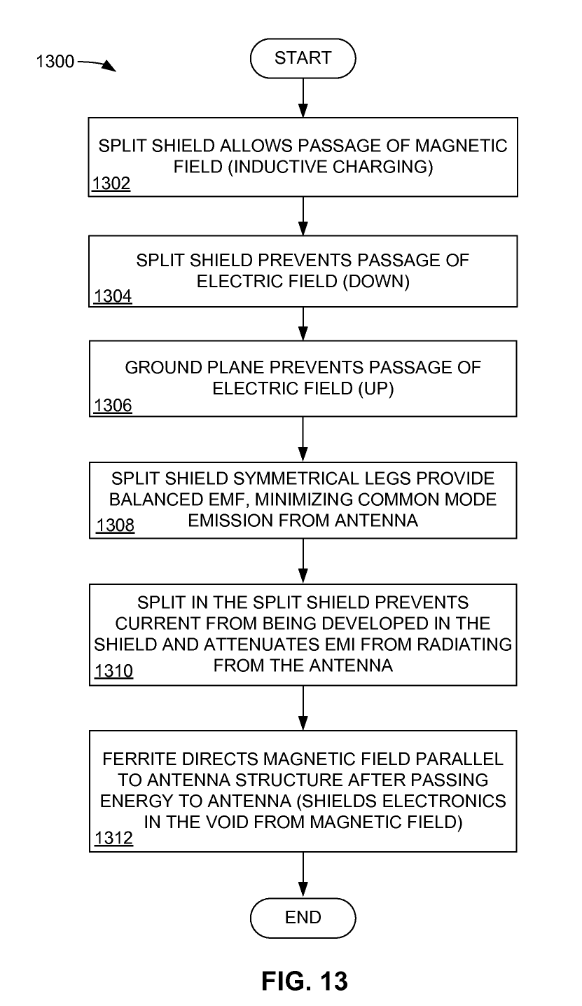

FIG. 13 is a flowchart illustrating an exemplary embodiment of a method 1300 for wireless power transfer. The blocks in the method 1300 can be performed in or out of the order shown. The description of the method 1300 will relate to the various embodiments described herein.

In block 1302, the split shield 710 (FIG. 7) allows passage of a magnetic field (inductive charging) to the antenna 718.

In block 1304, the split shield 710 prevents passage of electric field (EMI) (downward in FIG. 10).

In block 1306, the ground plane 838 prevents passage of electric field (upward in FIG. 10) and prevents EMI from radiating upward.

In block 1308, the symmetrical legs 722 and 724, and the circuit ground 713 of the split shield 710 provides balanced electro-motive force, which minimizes or cancels common mode emission from the antenna.

In block 1310, the gap 716 in the split shield 710 prevents current from being developed in the split shield 710 and attenuates EMI from radiating from the antenna.

In block 1312, the ferrite element 834 directs the magnetic field parallel to the antenna after passing power to the antenna, thus shielding electronics in the void 836 from the magnetic field.

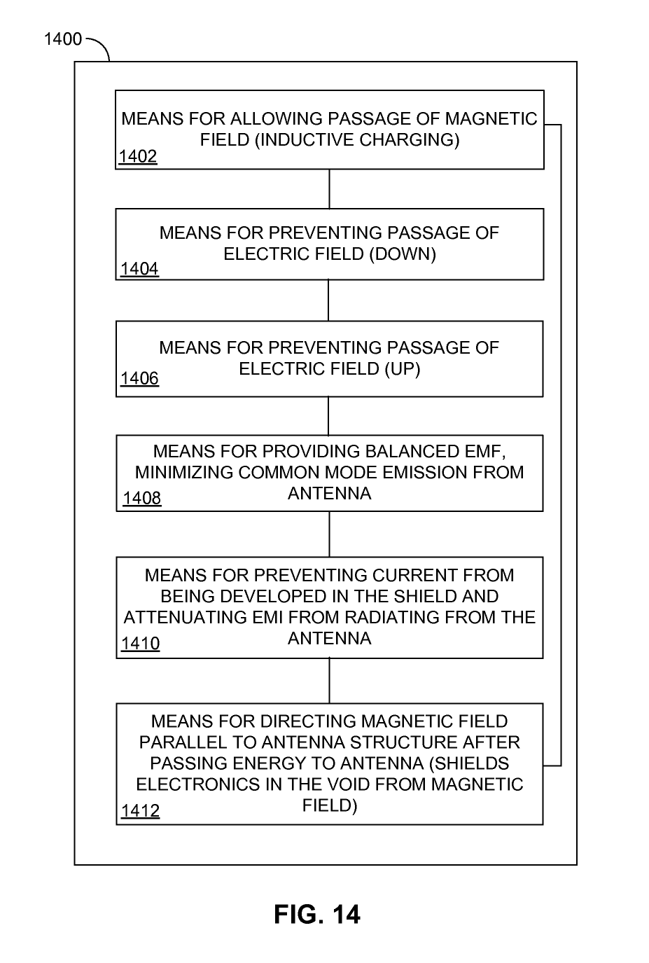

FIG. 14 is a functional block diagram of an apparatus 1400 for wireless power transfer.

The apparatus 1400 comprises means 1402 for allowing passage of a magnetic field (inductive charging) to the antenna 718. In certain embodiments, the means 1402 for allowing passage of a magnetic field (inductive charging) to the antenna 718 can be configured to perform one or more of the function described in operation block 1302 of method 1300 (FIG. 13). In an exemplary embodiment, the means 1402 for allowing passage of a magnetic field (inductive charging) to the antenna 718 may comprise the split shield 710 having the gap 716.

The apparatus 1400 further comprises means 1404 for preventing passage of electric field (EMI) (downward in FIG. 10). In certain embodiments, the means 1404 for preventing passage of electric field (EMI) can be configured to perform one or more of the function described in operation block 1304 of method 1300 (FIG. 13). In an exemplary embodiment, the means 1404 for preventing passage of electric field (EMI) may comprise the split shield 710.

The apparatus 1400 further comprises means 1406 for preventing passage of an electric field (upward in FIG. 10) and preventing EMI from radiating upward. In certain embodiments, the means 1406 for preventing passage of an electric field (upward in FIG. 10) and preventing EMI from radiating upward can be configured to perform one or more of the function described in operation block 1306 of method 1300 (FIG. 13). In an exemplary embodiment, the means 1406 for preventing passage of an electric field (upward in FIG. 10) and preventing EMI from radiating upward may comprise the ground plane 838.

The apparatus 1400 further comprises means 1408 for providing balanced electro-motive force, which minimizes or cancels common mode emission from the antenna. In certain embodiments, the means 1408 for providing balanced electro-motive force, which minimizes or cancels common mode emission from the antenna can be configured to perform one or more of the function described in operation block 1308 of method 1300 (FIG. 13). In an exemplary embodiment, the means 1408 for providing balanced electro-motive force, which minimizes or cancels common mode emission from the antenna, may comprise the symmetrical legs 722 and 724, and the circuit ground 713 of the split shield 710.

The apparatus 1400 further comprises means 1410 for preventing current from being developed in the split shield 710 and attenuating EMI from radiating from the antenna. In certain embodiments, the means 1410 for preventing current from being developed in the split shield 710 and attenuating EMI from radiating from the antenna can be configured to perform one or more of the function described in operation block 1310 of method 1300 (FIG. 13). In an exemplary embodiment, the means 1410 for preventing current from being developed in the split shield 710 and attenuating EMI from radiating from the antenna may comprise the split shield 710 having the gap 716.

The apparatus 1400 further comprises means 1412 for directing the magnetic field parallel to the antenna after passing power to the antenna, thus shielding electronics in the void 836 from the magnetic field. In certain embodiments, the means 1412 for directing the magnetic field parallel to the antenna after passing power to the antenna, thus shielding electronics in the void 836 from the magnetic field can be configured to perform one or more of the function described in operation block 1312 of method 1300 (FIG. 13). In an exemplary embodiment, the means 1412 for directing the magnetic field parallel to the antenna after passing power to the antenna, thus shielding electronics in the void 836 from the magnetic field may comprise the ferrite element 834.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and Blu-Ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

1. An antenna structure for wireless power transfer, comprising:
a ground plane configured to prevent passage of an electric field;
at least one coil configured as an antenna and located over the ground plane, the ground plane contiguous over the coil;
an insulator located between the ground plane and the at least one coil; and
a shield adjacent the coil, the shield comprising a non-contiguous structure, the shield configured to allow the passage of a magnetic field to the at least one coil.

2. The antenna structure of claim 1, wherein the shield is electrically coupled to a ground reference.

3. The antenna structure of claim 1, wherein the at least one coil and the shield are electrically coupled to a ground reference.

4. The antenna structure of claim 1, wherein the at least one coil is implemented as an electrically unbalanced structure.

5. The antenna structure of claim 1, wherein the non-contiguous structure prevents current from developing in the shield in response to the magnetic field.

6. The antenna structure of claim 1, wherein the shield comprises a center node and a plurality of symmetrical elements, the shield being coupled to a ground reference to which the at least one coil is coupled.

7. The antenna structure of claim 6, wherein the shield is configured to develop a substantially balanced electro-motive force.

8. The antenna structure of claim 7, wherein the substantially balanced electro-motive force reduces electro-magnetic interference emanating from the at least one coil.

9. The antenna structure of claim 7, wherein the substantially balanced electro-motive force improves common mode rejection in the at least one coil.

10. The antenna structure of claim 1, further comprising a ferrite element configured to prevent passage of a magnetic field to the ground plane.

11. The antenna structure of claim 10, wherein the ferrite element causes the magnetic field to flow along a major surface of the at least one coil.

12. The antenna structure of claim 1, wherein a periphery of the at least one coil is unshielded.

13. The antenna structure of claim 4, wherein the at least one coil is electrically coupled to half-bridge rectification circuitry.

14. The antenna structure of claim 1, wherein the shield comprises an electrically conductive material.

15. The antenna structure of claim 1, wherein the shield comprises a planar annular structure.

16. The antenna structure of claim 1, wherein the antenna is configured as a resonant structure configured to resonate at a frequency of an externally generated magnetic field, electrical current generated in the at least one coil in response to the externally generated magnetic field output to power or charge a load.

17. An antenna structure for a wireless power receiver, comprising:
a ground plane configured to prevent passage of an electric field;
at least one coil configured as an antenna and located over the ground plane, the ground plane contiguous over the coil;
an insulator located between the ground plane and the at least one coil;
a ferrite element located between the ground plane and the insulator; and
a shield adjacent the coil, the shield comprising a non-contiguous structure, the shield configured to allow the passage of a magnetic field to the at least one coil, the ferrite element configured to configured to prevent passage of the magnetic field to the ground plane.

18. The antenna structure of claim 17, wherein the at least one coil and the shield are electrically coupled to a ground reference.

19. The antenna structure of claim 17, wherein the non-contiguous structure prevents current from developing in the shield in response to the magnetic field.

20. The antenna structure of claim 17, wherein the shield comprises a center node and a plurality of symmetrical elements, the shield being coupled to a ground reference to which the at least one coil is coupled.

21. The antenna structure of claim 17, wherein the shield is configured to develop a substantially balanced electro-motive force, the substantially balanced electro-motive force reduces electro-magnetic interference emanating from the at least one coil and improves common mode rejection in the at least one coil.

22. The antenna structure of claim 17, wherein the ferrite element causes the magnetic field to flow along a major surface of the at least one coil.

23. The antenna structure of claim 17, wherein the shield comprises a planar annular structure and comprises an electrically conductive material.

24. The antenna structure of claim 17, wherein the insulator comprises a dielectric.

25. The antenna structure of claim 17, wherein the at least one coil is implemented as an electrically unbalanced structure.

26. The antenna structure of claim 25, wherein the at least one coil is electrically coupled to half-bridge rectification circuitry.

27. The antenna structure of claim 17, wherein the antenna is configured as a resonant structure.

28. A device for wireless power transfer, comprising:
means for allowing passage of a magnetic field to an antenna for wireless charging, the means for allowing passage of the magnetic field preventing passage of an electric field generated by the antenna; and
means for directing the magnetic field laterally away from the antenna.

29. A method for wireless power transfer, comprising:
allowing passage of a magnetic field to an antenna;
preventing passage of an electric field;
providing a balanced electro-motive force to the antenna;
directing the magnetic field parallel to the antenna; and
developing a current in the antenna responsive to the magnetic field, the current being received by a charge-receiving device configured to wirelessly receive power.

30. The method of claim 29, further comprising preventing current from developing in a non-contiguous shield located adjacent to the antenna in response to the magnetic field.
